(19) United States
(12) Patent Application Publication
(10) Pub. No.: US 2023/0409666 A1
(43) Pub. Date: Dec. 21, 2023

(54) COMPUTER-READABLE RECORDING MEDIUM STORING CALCULATION PROGRAM, CALCULATION METHOD, AND INFORMATION PROCESSING DEVICE

(71) Applicant: Fujitsu Limited, Kawasaki-shi (JP)

(72) Inventor: Yusuke NAGASAKA, Kawasaki (JP)

(73) Assignee: Fujitsu Limited, Kawasaki-shi (JP)

(21) Appl. No.: 18/117,485

(22) Filed: Mar. 6, 2023

(30) Foreign Application Priority Data
Jun. 15, 2022 (JP) 2022-096671

(51) Int. Cl. G06F 17/16

(52) U.S. Cl. CPC G06F 17/16

(57) ABSTRACT

A non-transitory computer-readable recording medium stores a calculation program. The calculation program causes a computer to execute a process comprising: dividing a problem matrix that corresponds to a linear equation, which has a plurality of vertices that corresponds to a plurality of variables of the linear equation, into a plurality of regions; executing, for the plurality of regions, processing of dividing one region of the problem matrix into a plurality of subproblem matrices by applying block coloring to the one region, and allocating a same color to subproblem matrices that have no dependency relationship of each other among the plurality of subproblem matrices; and calculating solutions of the plurality of variables of the linear equation by executing an iteration method for each of the subproblem matrices to which the same color is allocated.

### CROSS-REFERENCE TO RELATED APPLICATION

This application is based upon and claims the benefit of priority of the prior Japanese Patent Application No. 2022-096671, filed on Jun. 15, 2022, the entire contents of which are incorporated herein by reference.

### FIELD

The present embodiment discussed herein is related to a calculation program and the like.

### BACKGROUND

In a case where fluid applications, high performance conjugate gradient (HPCG) benchmarks, and the like are executed, processing of solving a linear equation Ax=b having sparse characteristics is executed, and an iteration method such as a conjugate gradient method is used for a solution. It is known that solving the linear equation Ax=b having sparse characteristics takes a huge amount of time. x and b in the linear equation Ax=b are vectors.

Here, as an example of generating a problem matrix, there is an existing method of discretizing a two-dimensional Poisson's equation and generating the linear equation Ax=b. FIG. 8 is a diagram for describing an existing method of generating a problem matrix. In the example illustrated in FIG. 8, a two-dimensional lattice 10 includes a plurality of lattice points xᵢ (i=0 to 8). For example, in a case of focusing on one certain lattice point, a problem matrix with a maximum of nine non-zero elements per row is finally generated, considering eight points around the focused lattice point.

Assuming that a diagonal component is “8” and a component of an element corresponding to a lattice point in contact with the target lattice point is “−1”, simultaneous equations 11 corresponding to the problem matrix is generated from the two-dimensional lattice 10. Equations corresponding to the simultaneous equations 11 and generated from the plurality of lattice points xᵢ (i=0 to 8) are the following Equations (1) to (9).

For example, focusing on the lattice point x₀, Equation (1) is generated. Focusing on the lattice point x₁, Equation (2) is generated. Focusing on the lattice point x₂, Equation (3) is generated. Focusing on the lattice point x₃, Equation (4) is generated. Focusing on the lattice point x₄, Equation (5) is generated. Focusing on the lattice point x₅, Equation (6) is generated. Focusing on the lattice point x₆, Equation (7) is generated. Focusing on the lattice point x₇, Equation (8) is generated. Focusing on the lattice point x₈, Equation (9) is generated.

8x₀−x₁−x₃−x₄=b₀ (1)

−x₀+8x₁−x₂−x₃−x₄−x₅=b₁ (2)

−x₁−8x₂−x₄−x₅=b₂ (3)

−x₀−x₁−8x₃−x₄−x₆−x₇=b₃ (4)

−x₀−x₁−x₂−x₃−8x₄−x₅−x₆−x₇−x₈=b₄ (5)

−x₁−x₂−x₄−8x₅−x₇=b₅ (6)

−x₃−x₄−8x₆−x₇=b₆ (7)

−x₃−x₄−x₅−x₆−8x₇−x₈=b₇ (8)

−x₄−x₅−x₇−8x₈=b₈ (9)

By initializing bᵢ and xᵢ included in the simultaneous equations 11 and applying an iterative solution method such as a Gauss-Seidel method illustrated in Equation (10), a value of xᵢ is solved. Processing content of the Gauss-Seidel method is similar to that of a Jacobi method. The Gauss-Seidel method improves convergence by using already updated elements to update the next value. Note that the respective equations have a dependency relationship and sequential processing is required. For example, Equations (1) and (2) have a dependency relationship at x₀.

$$\begin{matrix}[ Math . 1 ] & \\ {z}_{i}^{new} = \frac{1}{{a}_{ii}} ( {r}_{i} - {\sum }_{j = 0}^{i - 1} {a}_{ij} {z}_{j}^{new} - {\sum }_{j = i + 1}^{N - 1} {a}_{ij} {z}_{j}^{old} ) & ( 10 )\end{matrix}$$

When there is a dependency relationship as described above, parallelization is difficult and the dependency relationship becomes a bottleneck in solution processing. Note that, in the case of applying the Gauss-Seidel method of Equation (10) to the simultaneous equations 11, “z” is replaced with “x” and “r” is replaced with “b”. “aᵢᵢ” corresponds to an element in row i and column i of A in the linear equation.

Here, there is an existing technique called coloring. Coloring is based on whether there is a direct dependency relationship between elements, and allocates the same color to elements not having the direct dependency relationship as elements that can be processed in parallel. Check of the dependency relationship is made based on each element of the simultaneous equations. The elements allocated to the corresponding color are flagged and managed.

FIG. 9 is a diagram for describing coloring. The simultaneous equations 11 illustrated in FIG. 8 can be expressed by simultaneous equations 12 illustrated in FIG. 9. For example, Equations (1) to (9) can be expressed by the following Equations (11) to (19). In Equations (11) to (19), bᵢ is replaced with rᵢ for convenience.

x₀=(r₀+x₁+x₃+x₄)/8 (11)

x₁=(r₁+x₀+x₂+x₃+x₄+x₅)/8 (12)

x₂=(r₂+x₁+x₄+x₅)/8 (13)

x₃=(r₃+x₀+x₁+x₄+x₆+x₇)/8 (14)

x₄=(r₄+x₀+x₁+x₂+x₃+x₄+x₅+x₆+x₇+x₈)/8 (15)

x₅=(r₅+xᵢ+x₂+x₄+x₇+x₈)/8 (16)

x₆=(r₆+x₃+x₄+x₇)/8 (17)

x₇=(r₇+x₃+x₄+x₅+x₆)/8 (18)

x₈=(r₈+x₄+x₅+x₇)/8 (19)

Equations (11), (13), (17), and (19) have no direct dependency relationships according to Equations (11) to (19). Therefore, the lattice points x₀, x₂, x₆, and x₈ of the two-dimensional lattice 10 corresponding to Equations (11), (13), (17), and (19) are set to the same color (first color).

Equations (12) and (18) have no direct dependency relationship according to Equations (11) to (19). Therefore, the lattice points x₁ and x₇ of the two-dimensional lattice 10 corresponding to Equations (12) and (18) are set to the same color (second color).

Equations (14) and (16) have no direct dependency relationship according to Equations (11) to (19). Therefore, the lattice points x₃ and x₅ of the two-dimensional lattice 10 corresponding to Equations (14) and (16) are set to the same color (third color).

A color (fourth color) different from those of the lattice points x₁ to x₃ and x₅ to x₈ is set for the lattice point x₄ corresponding to the remaining Equation (15).

Parallel calculation is possible for the equations corresponding to the lattice points set to the same color by coloring. Note that, in the two-dimensional lattice points, it is necessary to allocate at least four colors depending on the upper, lower, left, right, and diagonal (eight elements). In three-dimensional lattice points, it is necessary to allocate at least eight colors depending on all of directions (twenty-six elements).

Next, block coloring will be described. Block coloring is performed by considering a plurality of variables as a group of variables. FIG. 10 is a diagram for describing block coloring. In the example illustrated in FIG. 10, a block 10a is generated considering the lattice points x₀, x₁, and x₂ included in the two-dimensional lattice 10 as a group. A block 10b is generated considering the lattice points x₃, x₄, and x₅ as a group. A block 10c is generated considering the lattice points x₆, x₇, and x₈ as a group. The example illustrated in FIG. 10 illustrates an example of generating blocks in which the rows of the two-dimensional lattice 10 are grouped together, but it is also possible to create a block that spans rows such as 2×2.

In block coloring, the dependency relationships are considered for all the elements in a block, and the color is set for each block based on the dependency relationships between blocks.

Since the blocks 10a and 10c have no dependency relationship, the same color (first color) is set for the lattice points x₀ to x₂ of the block 10a and the lattice points x₆ to x₈ of the block 10c.

The same color (second color) is set for the lattice points x₃ to x₅ included in the block 10b (note that the color different from the color set to the lattice points x₀ to x₂ of the block 10a is set).

By executing the block coloring illustrated in FIG. 10, the processing of the block 10b is alternately and repeatedly executed after the parallel processing of the blocks 10a and 10c is performed. Convergence is improved because of sequential processing in the block. Furthermore, since a group is made in the block, values corresponding to the lattice points in the block are stored close to each other in a memory, and locality is improved.

Japanese Laid-open Patent Publication No. 2020-13412 is disclosed as related art.

### SUMMARY

According to an aspect of the embodiments, a computer-readable recording medium storing a calculation program for causing a computer to execute a process including: dividing a problem matrix that corresponds to a linear equation, which has a plurality of vertices that corresponds to a plurality of variables of the linear equation, into a plurality of regions; executing, for the plurality of regions, processing of dividing one region of the problem matrix into a plurality of subproblem matrices by applying block coloring to the one region, and allocating a same color to subproblem matrices that have no dependency relationship of each other among the plurality of subproblem matrices; and calculating solutions of the plurality of variables of the linear equation by executing an iteration method for each of the subproblem matrices to which the same color is allocated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing a calculation example of a Gauss-Seidel method;

FIG. 2 is a diagram for describing processing of an information processing device according to the present embodiment;

FIG. 3 is a functional block diagram illustrating a configuration of the information processing device according to the present embodiment;

FIG. 4 is a flowchart illustrating a processing procedure of the information processing device according to the present embodiment;

FIG. 5 is a flowchart illustrating a processing procedure of calculation processing by the Gauss-Seidel method;

FIG. 6 is a diagram illustrating another example of a two-dimensional lattice;

FIG. 7 is a diagram illustrating an example of a hardware configuration of a computer that implements functions similar to the information processing device according to the embodiment;

FIG. 8 is a diagram for describing an existing method of generating a problem matrix;

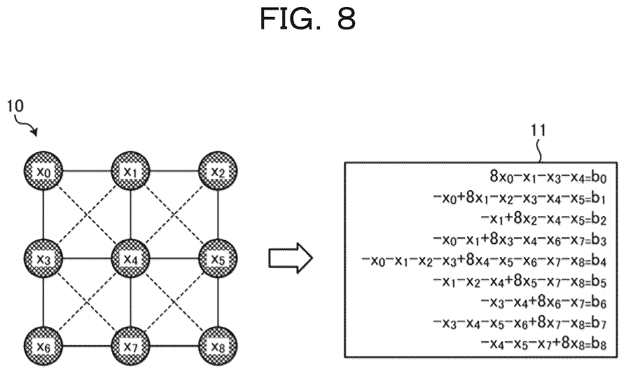

FIG. 9 is a diagram for describing coloring; and

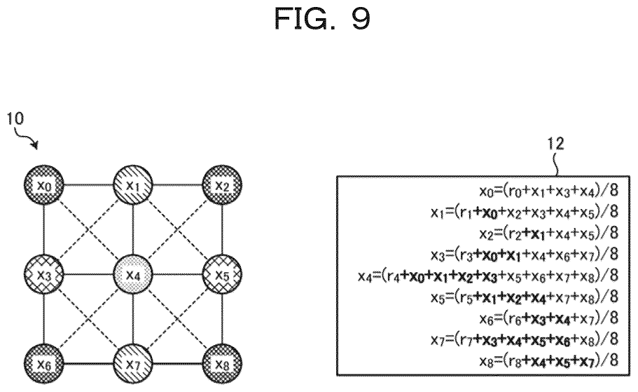

FIG. 10 is a diagram for describing block coloring.

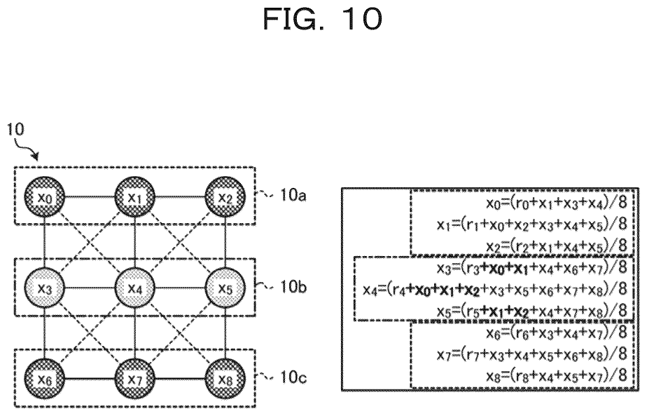

### DESCRIPTION OF EMBODIMENTS

In the above-described coloring, it is possible to extract parallelism by calculation using the Gauss-Seidel method, but there is a problem that the convergence deteriorates because it is not the same as sequential processing.

Meanwhile, the use of the block coloring enables sequential processing and improves the convergence, but the block coloring is a technique for central processing units (CPUs) with a small number of parallels. Therefore, in a case of solving a problem matrix, the block size tends to be large, resulting in a decrease in the number of parallels.

Therefore, it is required to improve both the convergence and parallelism in the case of solving a problem matrix.

In one aspect, an object of the present embodiment is to provide a calculation program, a calculation method, and an information processing device capable of improving both the convergence and parallelism in a case of solving a problem matrix.

Hereinafter, an embodiment of a calculation program, a calculation method, and an information processing device disclosed in the present application will be described in detail with reference to the drawings. Note that the present embodiment is not limited to the following embodiment.

### EMBODIMENT

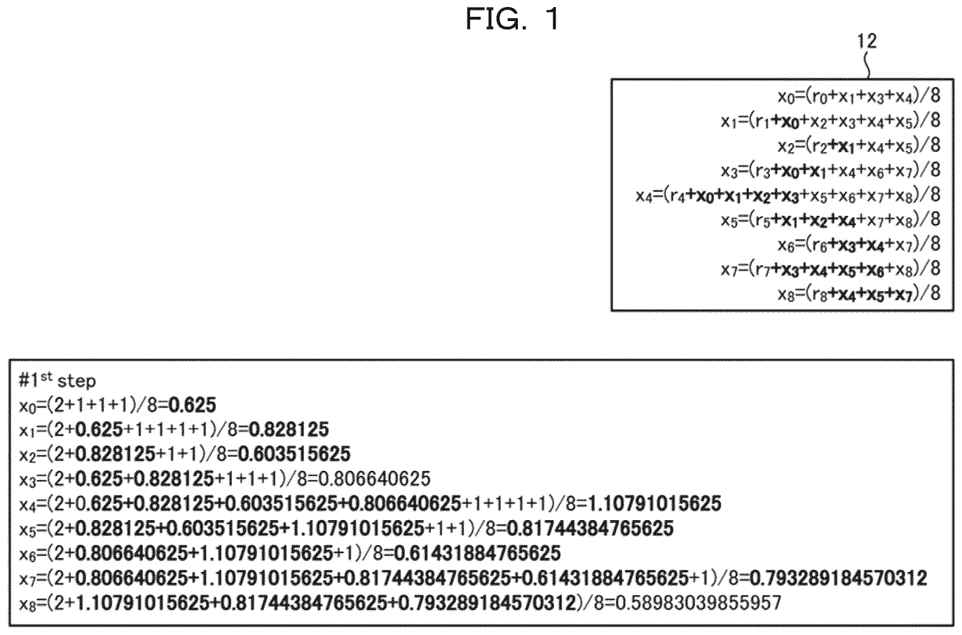

Before describing the present embodiment, a calculation example of the Gauss-Seidel method illustrated in Equation (10) will be described. FIG. 1 is a diagram for describing a calculation example of the Gauss-Seidel method. It is assumed that the Gauss-Seidel method is applied to the simultaneous equations 12 illustrated in Equations (11) to (19). It is assumed that an initial value of rᵢ is “2” and an initial value of the variable xᵢ is “1” (i=0 to 8).

Among iterative calculations of the Gauss-Seidel method, the value of the first variable x₀ is as follows.

x₀=(2+1+1+1)/8=0.625

The value of the first variable x₁ is as follows using the updated value of the variable x₀.

x₁=(2+0.625+1+1+1+1)/8=0.828125

The value of the first variable x₂ is as follows using the updated value of the variable x₁.

x₂=(2+0.828125+1+1)/8=0.603515625

The value of the first variable x₃ is as follows using the updated values of the variables x₀ and x₁.

x₃=(2+0.625+0.828125+1+1+1)/8=0.806640625

The value of the first variable x₄ is as follows using the updated values of the variables x₀, x₁, x₂, and x₃.

x₄=(2+0.625+0.828125+0.603515625+0.806640625+1+1+1+1)/8=1.10791015625

The value of the first variable x₅ is as follows using the updated values of the variables x₁, x₂, and x₄.

x₅=(2+0.828125+0.603515625+1.10791015625+1+1)/8=

The value of the first variable x₆ is as follows using the updated values of the variables x₃ and x₄.

x₆=(2+0.806640625+1.10791015625+1)/8=0.61431884765625

The value of the first variable x₇ is as follows using the updated values of the variables x₃, x₄, x₅, and x₆.

x₇=(2+0.806640625+1.10791015625+0.81744384765625+0.61431884765625+1)/8=0.793289184570312

The value of the first variable x₈ is as follows using the updated values of the variables x₄, x₅, x₆, and x₇.

x₈=(2+1.10791015625+0.81744384765625+0.793289184570312)/8=0.58983039855957

It is the Gauss-Seidel method that calculates the value of the variable xᵢ by repeatedly executing the above-described processing using the updated values from the second time onward. For example, in a case where the value of the variable xᵢ converges, the calculation is terminated.

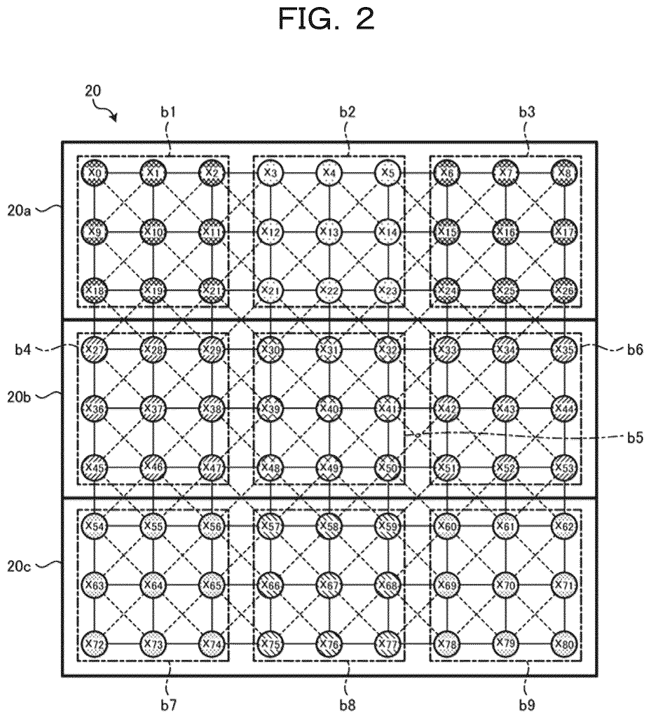

Next, processing of an information processing device according to the present embodiment will be described. FIG. 2 is a diagram for describing processing of the information processing device according to the present embodiment. The information processing device executes hierarchical coloring and then finds a solution using the Gauss-Seidel method.

In FIG. 2, description will be given using a two-dimensional lattice 20. The two-dimensional lattice 20 includes a lattice point xᵢ (i=0 to 80). It is assumed that an identification number is assigned to the lattice point xᵢ in order from the upper left lattice point x₀. It is assumed that the identification number assigned to the lattice point xᵢ is “i”. For example, the identification number assigned to the lattice point x₀ is “0”. The two-dimensional lattice 20 has a dependency relationship among the upper, lower, left, right, and diagonal lattice points.

The information processing device divides the two-dimensional lattice 20 into a plurality of regions 20a, 20b, and 20c based on the identification numbers set to the lattice points xᵢ included in the two-dimensional lattice 20. For example, the region 20a includes lattice points x₀ to x₂₆. The region 20b includes lattice points x₂₇ to x₅₃. The region 20c includes lattice points x₅₄ to x₈₀.

The information processing device divides the regions 20a to 20c into a plurality of blocks by executing block coloring after dividing the two-dimensional lattice 20 into the plurality of regions 20a to 20c. In the present embodiment, a case in which a region is divided into blocks with a block size of “3×3” will be described.

As illustrated in FIG. 2, the information processing device divides the region 20a into blocks b1, b2, and b3, regarding each of “the lattice points x₀ to x₂, x₉ to x₁₁, and x₁₈ to x₂₁”, “the lattice points x₃ to x₅, x₁₂ to x₁₄, and x₂₁ to x₂₃”, and “the lattice points x₆ to x₈, x₁₅ to x₁₇, and x₂₄ to x₂₆” as one variable.

In a case where there is no dependency relationship between “the lattice points x₀ to x₂, x₉ to x₁₁, and x₁₈ is to x₂₁” and “the lattice points x₆ to x₈, x₁₅ to x₁₇, and x₂₄ to x₂₆”, the information processing device applies two colors to the region 20a. For example, the information processing device allocates the first color to “the lattice points x₀ to x₂, x₉ to x₁₁, and x₁₈ to x₂₁” and “the lattice points x₆ to x₈, x₁₅ to x₁₇, and x₂₄ to x₂₆”. The information processing device allocates the second color to “the lattice points x₃ to x₅, x₁₂ to x₁₄, and x₂₁ to x₂₃”.

The information processing device divides the region 20b into blocks b4, b5, and b6, regarding each of “the lattice points x₂₇ to x₂₉, x₃₆ to x₃₈, and x₄₅ to x₄₇”, “the lattice points x₃₀ to x₃₂, x₃₉ to x₄₁, and x₄₈ to x₅₀”, and “the lattice points x₃₃ to x₃₅, x₄₂ to x₄₄, and x₅₁ to x₅₃” as one variable.

In a case where there is no dependency relationship between “the lattice points x₂₇ to x₂₉, x₃₆ to x₃₅, and x 45 to x₄₇” and “the lattice points x₃₃ to x₃₅, x₄₂ to x₄₄, and x₅₁ to x₅₃”, the information processing device applies two colors to the region 20b. For example, the information processing device allocates the third color to “the lattice points x₂₇ to x₂₉, x₃₆ to x₃₈, and x₄₅ to x₄₇” and “the lattice points x₃₃ to x₃₅, x₄₂ to x₄₄, and x₅₁ to x₅₃”. The information processing device allocates the fourth color to “the lattice points x₃₀ to x₃₂, x₃₉ to x₄₁, and x₄₈ to x₅₀”.

The information processing device divides the region 20b into blocks b7, b8, and b9, regarding each of “the lattice points x₅₄ to x₅₆, x₆₃ to x₆₅, and x₇₂ to x₇₄”, “the lattice points x₅₇ to x₅₉, x₆₆ to x₆₅, and x₇₅ to x₇₇”, and “the lattice points x₆₀ to x₆₂, and x₆₉ to x₇₁, and x₇₈ to x₈₀” as one variable.

In a case where there is no dependency relationship between “the lattice points x₅₄ to x₅₆, x₆₃ to x₆₅, and x₇₂ to x₇₄” and “the lattice points x₆₀ to x₆₂, and x₆₉ to x₇₁, and x 78 to x₈₀”, the information processing device applies two colors to the region 20c. For example, the information processing device allocates the fifth color to “the lattice points x₅₄ to x₅₆, x₆₃ to x₆₅, and x₇₂ to x₇₄” and “the lattice points x₆₀ to x₆₂, x₆₉ to x₇₁, and x₇₈ to x₈₀”. The information processing device allocates the sixth color to “the lattice points x₅₇ to x₅₉, x₆₆ to x₆₈, and x₇₅ to x₇₇”.

As described above, the information processing device allocates six colors to the lattice points included in the two-dimensional lattice 20 by executing block coloring for each of the regions 20a to 20c. In the following description, a problem matrix corresponding to the respective lattice points included in the same block is referred to as a “subproblem matrix”.

Next, the information processing device applies the calculation of the Gauss-Seidel method to each lattice point (variable) included in each block for each of the regions 20a to 20c, and sequentially processes the lattice point. The information processing device completes the processing in order of the regions 20a, 20b, and 20c, and can transmit a better update result to the next region. The information processing device processes the blocks having elements belonging to the same color in parallel within a region.

For example, in the case of performing the processing for the region 20a, the information processing device processes each lattice point included in the block b1 and each lattice point included in the block b3 in parallel. After performing the parallel processing for the blocks b1 and b3 once, the information processing device performs the processing for the block b2 once and shifts to the processing for the region 20b.

In the case of performing the processing for the region 20b, the information processing device processes each lattice point included in the block b4 and each lattice point included in the block b6 in parallel. After performing the parallel processing for the blocks b4 and b6 once, the information processing device performs the processing for the block b5 once and shifts to the processing for the region 20c.

In the case of performing the processing for the region 20c, the information processing device processes each lattice point included in the block b7 and each lattice point included in the block b9 in parallel. After performing the parallel processing for the blocks b7 and b9 once, the information processing device performs the processing for the block b5 once and returns to the processing for the region 20a.

The information processing device solves the value of the lattice point xᵢ included in the two-dimensional lattice 20 by repeatedly executing the above-described processing.

As described above, the information processing device according to the present embodiment divides the problem matrix into a plurality of regions, performs block coloring within each region, and sequentially applies the Gauss-Seidel method to each region to obtain the solution. Therefore, both the convergence and parallelism in the case of solving the problem matrix can be improved.

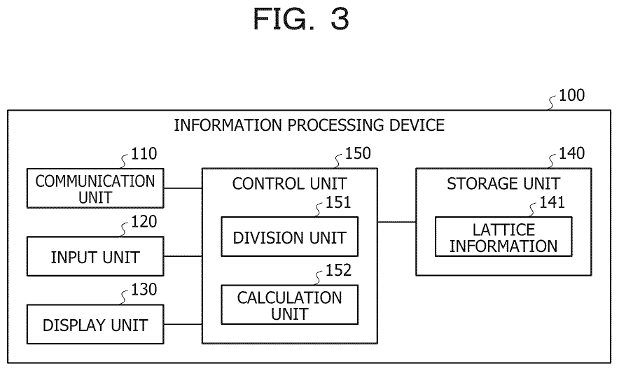

Next, a configuration example of the information processing device according to the present embodiment will be described. FIG. 3 is a functional block diagram illustrating a configuration of the information processing device according to the present embodiment. As illustrated in FIG. 3, an information processing device 100 according to the present embodiment includes a communication unit 110, an input unit 120, a display unit 130, a storage unit 140, and a control unit 150.

The communication unit 110 is coupled to an external device or the like via a network and receives various types of data. For example, the communication unit 110 is implemented by a network interface card (NIC) or the like.

The input unit 120 is an input device that inputs various types of information to the information processing device 100. The input unit 120 corresponds to a keyboard, a mouse, a touch panel, or the like.

The display unit 130 is a display device that displays information output from the control unit 150. The display unit 130 corresponds to a liquid crystal display, an organic electro luminescence (EL) display, a touch panel, or the like.

The storage unit 140 has lattice information 141. The storage unit 140 is implemented by, for example, a semiconductor memory element such as a random access memory (RAM) or a flash memory, or a storage device such as a hard disk or an optical disk.

The lattice information 141 includes a d-dimensional lattice (d=1, 2, or 3). In the example described with reference to FIG. 2, the two-dimensional lattice 20 is illustrated as the lattice information 141.

The control unit 150 has a division unit 151 and a calculation unit 152. The control unit 150 is implemented by, for example, a central processing unit (CPU) or a micro processing unit (MPU). Furthermore, the control unit 150 may be executed by, for example, an integrated circuit such as an application specific integrated circuit (ASIC) or a field programmable gate array (FPGA).

The division unit 151 acquires the lattice information 141 and divides the d-dimensional lattice corresponding to the lattice information 141 into a plurality of regions. The example in FIG. 2 illustrates an example in which the division unit 151 divides the two-dimensional lattice 20 into the regions 20a to 20c.

The division unit 151 determines a division size N of the regions to be divided based on parallelism P. The division size N of the region is the number of lattice points included in the region. The division unit 151 determines the division size N that satisfies Condition 1 in a case where the lattice points of the two-dimensional lattice to be divided have an upper, lower, right, left, and diagonal dependency relationship (eight vertices around). In Condition 1, bx×by is the block size and is preset. The parallelism P is set in advance from hardware characteristics of the information processing device 100. In the case where there is the upper, lower, right, left, and diagonal dependency relationship (eight vertices around), at least application of four colors is required.

P<(N/(bx×by))/4 (Condition 1)

Note that the division unit 151 determines the division size N to satisfy Condition 2 in a case where the lattice points of the two-dimensional lattice to be divided have an upper, lower, right, and left dependency relationship (four vertices around). In the case where there is the upper, lower, right, and left dependency relationship (four vertices around), at least application of two colors is required.

P<(N/(bx×by))/2 (Condition 2)

By the way, in a case where the lattice corresponding to the lattice information 141 is a three-dimensional lattice, the division unit 151 determines the division size N of the region to be divided as follows. The division unit 151 determines the division size N that satisfies Condition 3 in a case where the lattice points of the three-dimensional lattice to be divided have an upper, lower, right, left, front, rear, and diagonal dependency relationship (twenty-six vertices around). In Condition 3, bx×by×bz is the block size and is preset. In the case where there is the upper, lower, right, left, front, rear, and diagonal dependency relationship (twenty-six vertices around), at least application of eight colors is required.

P<(N/(bx×by×bz))/8 (Condition 3)

The division unit 151 determines the division size N to satisfy Condition 4 in a case where the lattice points of the three-dimensional lattice to be divided have an upper, lower, right, left, front, and rear dependency relationship (six vertices around). In the case where there is the upper, lower, right, left, front and rear dependency relationship (six vertices around), at least application of two colors is required.

P<(N/(bx×by×bz))/2 (Condition 4)

In summary, the division unit 151 determines the division size N of the region to satisfy Condition 5. In Condition 5, k is a preset coefficient. C is the minimum number of colors in separate coloring. Note that the block size is “bx” for one dimension, “bx×by” for two dimensions, and “bx×by×bz” for three dimensions.

N>k×C×P×(bx×by×bz) (Condition 5)

The division unit 151 may adjust the division size N within a range that satisfies Condition 5. For example, the division unit 151 may determine a minimum value of the division size N within the range that satisfies Condition 5, or may set a value divisible by the block size as the value of the division size N.

The division unit 151 divides the d-dimensional lattice (d=1, 2 or 3) corresponding to the lattice information 141 based on the determined division size N, and outputs the divided d-dimensional lattices to the calculation unit 152. For example, in the example described with reference to FIG. 2, the two-dimensional lattice 20 is divided into the regions 20a to 20c, and a division result is output to the calculation unit 152.

In the case of dividing the d-dimensional lattice according to the division size N, the division unit 151 sets the identification numbers of the lattice points included in the division size N to be consecutive numbers. In the example described with reference to FIG. 2, the identification numbers of the lattice points included in the regions 20a to 20c are serial numbers.

The calculation unit 152 sequentially executes the calculation by the Gauss-Seidel method for each of the divided regions. The calculation unit 152 sequentially processes the variables corresponding to the lattice points in each block included in the region by the calculation using the Gauss-Seidel method. The calculation unit 152 completes the processing in order of the plurality of regions and can transmit the better update result to the next region.

The description of other processes in which the calculation unit 152 sequentially executes the calculation by the Gauss-Seidel method for each of the divided regions is similar to the description given in FIG. 2.

The calculation unit 152 outputs the values of xᵢ obtained as a result of the sequential execution of the calculation by the Gauss-Seidel method to the display unit 130 for display.

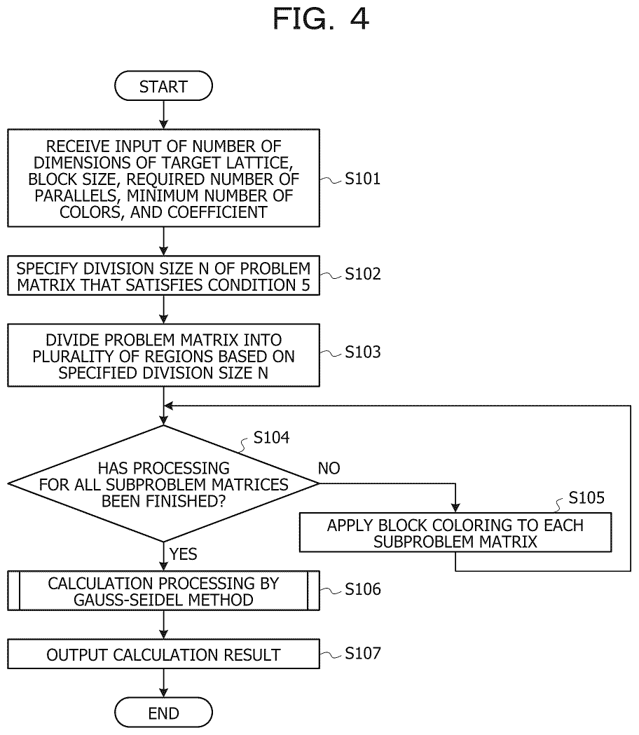

Next, an example of a processing procedure of the information processing device 100 according to the present embodiment will be described. FIG. 4 is a flowchart illustrating the processing procedure of the information processing device according to the present embodiment. As illustrated in FIG. 4, the division unit 151 of the information processing device 100 receives inputs of the number of dimensions of the target lattice, the block size, the required number of parallels, the minimum number of colors, and the coefficient (step S101).

The division unit 151 specifies the division size N of the problem matrix that satisfies Condition 5 (step S102). The division unit 151 divides the problem matrix into a plurality of regions based on the specified division size N (step S103).

In a case where the calculation unit 152 of the information processing device 100 has not finished the processing for all the subproblem matrices (step S104, No), the calculation unit 152 applies the block coloring to each subproblem matrix (step S105) and moves to step S104.

On the other hand, in a case where the calculation unit 152 has finished the processing for all the subproblem matrices (step S104, Yes), the calculation unit 152 executes calculation processing using the Gauss-Seidel method (step S106). The calculation unit 152 outputs the calculation result to the display unit 130 (step S107).

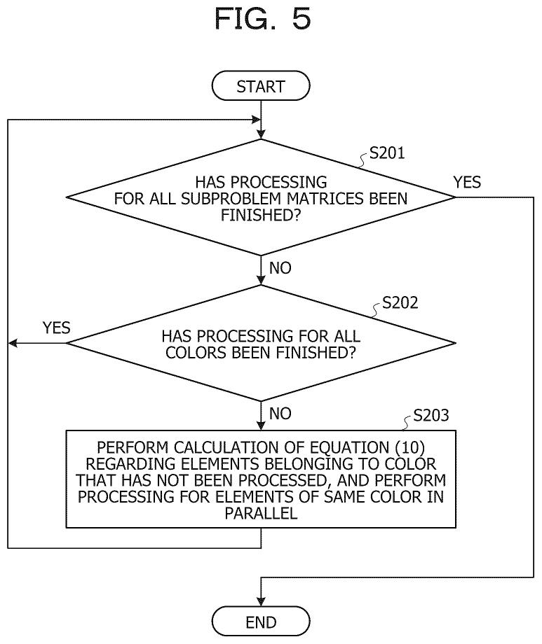

Next, the calculation processing by the Gauss-Seidel method illustrated in step S106 of FIG. 4 will be described. FIG. 5 is a flowchart illustrating a processing procedure of the calculation processing by the Gauss-Seidel method. As illustrated in FIG. 5, the calculation unit 152 of the information processing device 100 terminates the processing in a case where the calculation unit 152 finished the processing for all the subproblem matrices (step S201, Yes).

In a case where the calculation unit 152 has not finished the processing for all the subproblem matrices (step S201, No), the calculation unit 152 determines whether the processing has been finished for all the colors (step S202). In a case where the calculation unit 152 has finished the processing for all the colors (step S202, Yes), the processing proceeds to step S201.

In a case where the calculation unit 152 has not finished the processing for all the colors (step S202, No), the processing proceeds to step S203. The calculation unit 152 performs calculation of Equation (10) for the elements belonging to colors that have not been processed. Furthermore, the calculation unit 152 executes the processing in parallel for the elements of the same color (step S203). The calculation unit 152 proceeds to step S201 after the processing of step S203.

As described above, the information processing device 100 divides the problem matrix into a plurality of regions, performs block coloring within each region, and sequentially applies the Gauss-Seidel method to each region to obtain the solution. Therefore, both the convergence and parallelism in the case of solving the problem matrix can be improved. For example, the improved convergence reduces the number of iterations by the Gauss-Seidel method. The improved parallelism reduces a processing time per iteration processing.

The information processing device 100 divides the problem matrix into a plurality of regions such that the numbers of respective vertices included in the same region become consecutive numbers. As a result, in the case where the region is divided into blocks, the identification numbers of the lattice points in the block are close to each other, and the locality can be improved.

The information processing device 100 applies the Gauss-Seidel method to each subproblem matrix to which the same color is allocated and which is included in the subproblem matrices to calculate solutions of a plurality of variables of a linear equation. Therefore, it becomes possible to improve the parallelism.

The information processing device 100 specifies the size of the region to be divided based on the hardware-based parallelism, the dependency relationship of the variables corresponding to the respective vertices included in the problem matrix, and the size of the subproblem matrix. Therefore, it is possible to divide the problem matrix according to the optimal division size.

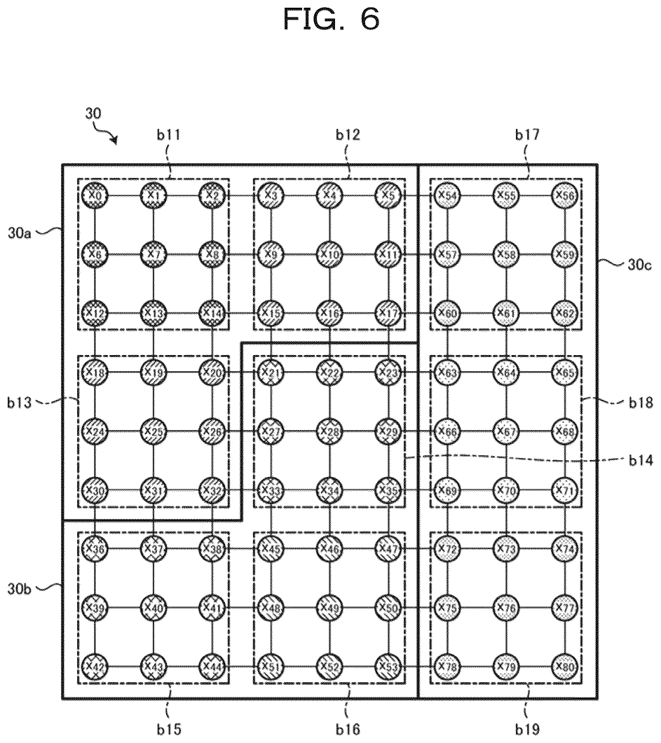

Here, the processing executed by the information processing device 100 according to the present embodiment will be supplemented. FIG. 6 is a diagram illustrating another example of a two-dimensional lattice. A two-dimensional lattice 30 includes a lattice point xᵢ (i=0 to 80). It is assumed that an identification number is assigned to the lattice point xᵢ from the upper left lattice point x₀. Note that the identification number is different from that in the two-dimensional lattice 20 illustrated in FIG. 2. In the two-dimensional lattice the upper, lower, right, and left lattice points have a dependency relationship, and the diagonal lattice points do not have a dependency relationship.

The division unit 151 of the information processing device 100 divides the two-dimensional lattice 30 into a plurality of regions 30a, 30b, and based on the identification numbers set to the lattice points x, included in the two-dimensional lattice 30. For example, the region 30a includes lattice points x₀ to x₂₀, x₂₄ to x₂₆, and x₃₀ to x₃₂. The region 30b includes lattice points x₂₁ to x₂₃, x₂₇ to x₂₉, and x₃₃ to x₅₃. The region 30c includes lattice points x₅₄ to x₈₀.

The calculation unit 152 of the information processing device 100 divides the divided regions 30a to 30c into a plurality of blocks by executing block coloring.

The calculation unit 152 divides the region 30a into blocks b11, b12, and b13, regarding each of “the lattice points x₀ to x₂, x₆ to x₈, and x₁₂ to x₁₄”, “the lattice points x₃ to x₅, x₉ to x₁₁, and x₁₅ to x₁₇”, and “the lattice points x₁₈ to x₂₀, x₂₄ to x₂₆, and x₃₀ to x₃₂” as one variable. The calculation unit 152 allocates the same color to each lattice point of blocks having no dependency relationship, similarly to FIG. 2.

The calculation unit 152 divides the region 30b into blocks b14, b15, and b16, regarding each of “the lattice points x₂₁ to x₂₃, x₂₇ to x₂₉, and x₃₃ to x₃₅”, “the lattice points x 36 to x 38, x 39 to x₄₁, and x₄₂ to x₄₄”, and “the lattice points x₄₅ to x₄₇, x₄₈ to x₅₀, and x₅₁ to x₅₃” as one variable. The calculation unit 152 allocates the same color to each lattice point of blocks having no dependency relationship, similarly to FIG. 2.

The calculation unit 152 divides the region 30c into blocks b17, b18, and b19, regarding each of “the lattice points x₅₄ to x₅₆, x₅₇ to x₅₉, and x₆₀ to x₆₂”, “the lattice points x₆₃ to x₆₅, x₆₆ to x₆₃, and x₆₉ to x₇₁”, and “the lattice points x₇₂ to x₇₄, x₇₅ to x₇₇, and x₇₃ to x₈₀” as one variable. The calculation unit 152 allocates the same color to each lattice point of blocks having no dependency relationship, similarly to FIG. 2.

The information processing device applies the calculation of the Gauss-Seidel method to each lattice point (variable) included in each block for each of the regions 30a to 30c, and sequentially processes the lattice point.

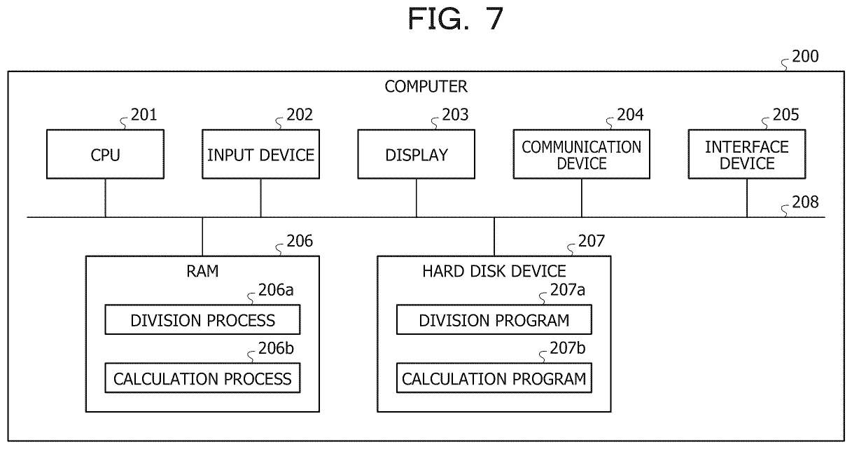

Next, an example of a hardware configuration of a computer that implements functions similar to those of the information processing device 100 indicated in the embodiment described above will be described. FIG. 7 is a diagram illustrating an example of the hardware configuration of the computer that implements the functions similar to those of the information processing device of the embodiment.

As illustrated in FIG. 7, a computer 200 includes a CPU 201 that executes various types of arithmetic processing, an input device 202 that accepts data input from a user, and a display 203. Furthermore, the computer 200 includes a communication device 204 that exchanges data with an external device or the like via a wired or wireless network, and an interface device 205. Furthermore, the computer 200 includes a RAM 206 that temporarily stores various types of information, and a hard disk device 207. Additionally, each of the devices 201 to 207 is coupled to a bus 208.

The hard disk device 207 includes a division program 207a and a calculation program 207b. Furthermore, the CPU 201 reads each of the programs 207a and 207b, and loads the program into the RAM 206.

The division program 207a functions as a division process 206a. The calculation program 207b functions as a calculation process 206b.

The processing of the division process 206a corresponds to the processing of the division unit 151. The processing of the calculation process 206b corresponds to the processing of the calculation unit 152.

Note that each of the programs 207a and 207b may not necessarily be stored in the hard disk device 207 beforehand. For example, each of the programs may be stored in a “portable physical medium” to be inserted into the computer 200, such as a flexible disk (FD), a compact disc read only memory (CD-ROM), a digital versatile disc (DVD), a magneto-optical disk, or an integrated circuit (IC) card. Then, the computer 200 may read and execute each of the programs 207a and 207b.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a calculation program for causing a computer to execute a process comprising:
dividing a problem matrix that corresponds to a linear equation, which has a plurality of vertices that corresponds to a plurality of variables of the linear equation, into a plurality of regions;
executing, for the plurality of regions, processing of dividing one region of the problem matrix into a plurality of subproblem matrices by applying block coloring to the one region, and allocating a same color to subproblem matrices that have no dependency relationship of each other among the plurality of subproblem matrices; and
calculating solutions of the plurality of variables of the linear equation by executing an iteration method for each of the subproblem matrices to which the same color is allocated.

2. The non-transitory computer-readable recording medium according to claim 1, wherein a number is assigned to each of the vertices included in the problem matrix, and the processing of dividing the problem matrix into the plurality of regions includes dividing the problem matrix into the plurality of regions such that the numbers of the respective vertices included in the same region become consecutive numbers.

3. The non-transitory computer-readable recording medium according to claim 1, wherein in the calculating the solutions of the plurality of variables, the iteration method is a Gauss-Seidel method.

4. The non-transitory computer-readable recording medium according to claim 1, the process further comprising:
specifying a size of the region to be divided based on parallelism based on hardware that executes the processing of calculating, the dependency relationship of the variables that correspond to the respective vertices included in the problem matrix, and a size of the subproblem matrix.

5. A calculation method to be performed by a computer, the method comprising:
dividing a problem matrix that corresponds to a linear equation, which has a plurality of vertices that corresponds to a plurality of variables of the linear equation, into a plurality of regions;
executing, for the plurality of regions, processing of dividing one region of the problem matrix into a plurality of subproblem matrices by applying block coloring to the one region, and allocating a same color to subproblem matrices that have no dependency relationship of each other among the plurality of subproblem matrices; and
calculating solutions of the plurality of variables of the linear equation by executing an iteration method for each of the subproblem matrices to which the same color is allocated.

6. The calculation method according to claim 5, wherein a number is assigned to each of the vertices included in the problem matrix, and the processing of dividing the problem matrix into the plurality of regions includes dividing the problem matrix into the plurality of regions such that the numbers of the respective vertices included in the same region become consecutive numbers.

7. The calculation method according to claim 5, wherein in the calculating the solutions of the plurality of variables, the iteration method is a Gauss-Seidel method.

8. The calculation method according to claim 5, the method further comprising:
specifying a size of the region to be divided based on parallelism based on hardware that executes the processing of calculating, the dependency relationship of the variables that correspond to the respective vertices included in the problem matrix, and a size of the subproblem matrix.

9. An information processing device comprising:
a memory, and
a processor coupled to the memory and configured to:
divide a problem matrix that corresponds to a linear equation, which has a plurality of vertices that corresponds to a plurality of variables of the linear equation, into a plurality of regions;
execute, for the plurality of regions, processing of dividing one region of the problem matrix into a plurality of subproblem matrices by applying block coloring to the one region, and allocating a same color to subproblem matrices that have no dependency relationship of each other among the plurality of subproblem matrices; and
calculate solutions of the plurality of variables of the linear equation by executing an iteration method for each of the subproblem matrices to which the same color is allocated.

10. The information processing device according to claim 9, wherein the processor is further configured to assign a number to each of the vertices included in the problem matrix, and
wherein the processing of dividing the problem matrix into the plurality of regions includes dividing the problem matrix into the plurality of regions such that the numbers of the respective vertices included in the same region become consecutive numbers.

11. The information processing device according to claim 9, wherein in the calculating the solutions of the plurality of variables, the iteration method is a Gauss-Seidel method.

12. The information processing device according to claim 9, the processor is further configured to:
specify a size of the region to be divided based on parallelism based on hardware that executes the processing of calculating, the dependency relationship of the variables that correspond to the respective vertices included in the problem matrix, and a size of the subproblem matrix.
